(19) United States
(12) Patent Application Publication
(10) Pub. No.: US 2005/0077372 A1
(43) Pub. Date: Apr. 14, 2005

(54) Drinking straw holder for a bottle

(75) Inventor: Alex M. Greenberg, New York, NY (US)

Correspondence Address: COHEN, PONTANI, LIEBERMAN & PAVANE, 551 FIFTH AVENUE, SUITE 1210, NEW YORK, NY, 10176, US

(73) Assignee: Greenberg Surgical Technologies, LLC

(21) Appl. No.: 10/888,681

(22) Filed: Jul. 9, 2004

Related U.S. Application Data
(63) Continuation-in-part of application No. 10/684,882, filed on Oct. 14, 2003.

(51) Int. Cl. B05B 17/08; E03B 9/20; B05B 12/14; A61J 15/00; A47G 21/18; B65D 39/00

(52) U.S. Cl. 239/33; 239/17; 239/29.3

(57) ABSTRACT

A straw holder for vertically supporting a drinking straw in the mouth of a bottle containing a beverage to be consumed and for limiting vertical movement of the straw with respect to the bottle. The straw holder includes a straw support portion dimensioned for placement across the mouth of the bottle and having an aperture defined in the straw support. The aperture receives the drinking straw so that the straw is disposed through the aperture with a leading edge of the straw positioned in the bottle in communication with the beverage. The aperture is dimensioned for adjustably maintaining a vertical position of the leading edge of the straw in the bottle once a desired vertical position is selected. The straw holder also includes a bottle retaining portion coupled to the straw support portion for maintaining the position of the straw support across the mouth of the bottle. The bottle retaining portion includes a pair of slits having edge portions which are spaced apart for engaging the ramps or flange on neck of the bottle.

### RELATED APPLICATIONS

This application is a continuation-in-part of U.S. application Ser. No. 10/684,882 filed on Oct. 14, 2003.

### BACKGROUND OF THE INVENTION

1. Field of the Invention

The invention relates to a straw holder for vertically supporting and orienting a drinking straw in the mouth of a bottle.

2. Description of the Related Art

Consumers of beverages under some circumstances may prefer to drink directly from a bottle through a straw. While driving a car, for example, bottled liquid is less subject to spillage, but tipping up the bottle for a drink interrupts a driver's view of the road. Use of a straw with a bottle addresses both the spillage and safety issues, but presents a problem when a too-short straw falls into a too-long bottle. In addition, carbon dioxide bubbles from a carbonated beverage may accumulate on the straw and cause it to rise out of the bottle. It would, therefore, be desirable to support the straw vertically in the bottle so that it cannot fall in or rise out. At the same time, it would be desirable to stabilize the angular position of the straw so that it cannot rotate within the mouth of the bottle. A device addressing this problem could also be used by invalids who may not have full use of their hands.

The problem of stabilizing a straw with respect to the lip of a cup is addressed by U.S. Pat. No. 5,823,493, which discloses a straw holder cut from a sheet material such as paper. The holder includes a retaining portion having an aperture which receives a standard drinking straw therethrough, and a pair of wings having ends which are clipped together and fitted against the outside of the cup.

The problem of stabilizing the position of a straw in a bottle by means of a simple fabricated device does not appear to have been solved. U.S. Pat. No. 3,606,156 discloses a drinking straw formed with an intake portion received in a bottle, a helical portion fitted around the neck of the bottle, and an outlet to which suction is applied by a consumer. The object is to stabilize the position of a straw for use by small children, but the circuitous path of the straw requires considerable effort to draw liquid. Further, the specially formed straw is a three dimensional object which is relatively expensive to manufacture and inconvenient to store and transport in any quantity. As such it is not suitable for use as a “give-away” item with a bottled beverage.

Other prior art describes straw holders for positioning a straw with respect to the lip of a cup. See, e.g., U.S. Pat. Nos. 2,070,495 and 5,823,493. The latter discloses a straw holder which can be cut from a sheet material and relies on the straw itself to position the holder on the cup.

### SUMMARY OF THE INVENTION

The object of the invention is to provide a simply and economically manufactured device for stabilizing the position of a straw received in the mouth of a bottle.

According to the invention, this object is achieved by a straw holder including a straw support portion having a central aperture dimensioned to receive a straw in an interference fit, and a bottle retaining portion surrounding the support portion and having at least two edge portions facing the straw support portion and spaced for engaging the thread ramps or flange of a bottle adjacent to its mouth, the support portion being attached to the bottle retaining portion by at least one connection located between the edge portions.

According to preferred embodiments, the edge portions are formed by respective slits which separate the straw support portion from the bottle retaining portion. The slits are preferably curved so that they conform to the profile of a bottle neck and have greater surface area for engaging a flange or the thread ramps of a bottle having a screw-on cap. The bottle retaining ramp may also be provided with turns lying radially outside of the slits, for additional retention around the bottle.

The straw holder according to the invention can be simply fabricated from a sheet material such as paper, cardboard, or plastic such as polyurethane. The sheet material is preferably die-cut to form slits which define the central aperture and the edge portions which provide bottle retention. The straw holder itself is preferably two dimensional when not in use, and may therefore be stacked to provide considerable economy of space. Since the straw holder according to the invention may be manufactured even more cheaply than lids for disposable cups, it is suitable for use as a “give-away”, optionally provided with a straw at the point of sale for a bottled beverage. As such, straw manufacturers might wish to provide the straw holder as a “value added” item.

The straw holder according to the invention may also include advertising media and may have a promotional item such as a CD attached. To this end, the bottle retaining portion may be provided with circumferentially spaced slits for engaging the circumferential edge of a CD.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a plan view of an embodiment of a straw holder according to the invention, having parallel retention slits;

FIG. 2 is a plan view of another embodiment of a straw holder having retention slits with curved portions;

FIG. 3 is an elevation view of the straw holder of FIG. 2 fitted to a bottle;

FIG. 4 is a plan view of another embodiment of a straw holder having curved retention slits and an outer spiral portion with CD retaining slits;

FIG. 5 is a plan view of another embodiment of a straw holder having overlapping retaining slits and an outer spiral portion;

FIG. 6A is a plan view of a blank for making a skirt-type straw holder;

FIG. 6B is a perspective view of the skirt-type straw holder made using the blank of FIG. 6A;

FIG. 7A is a perspective view of a straw holder having a post for retaining a CD; and

FIG. 7B is a side view of the straw holder of FIG. 7A with a CD in place.

### DETAILED DESCRIPTION OF THE PRESENTLY PREFERRED EMBODIMENTS

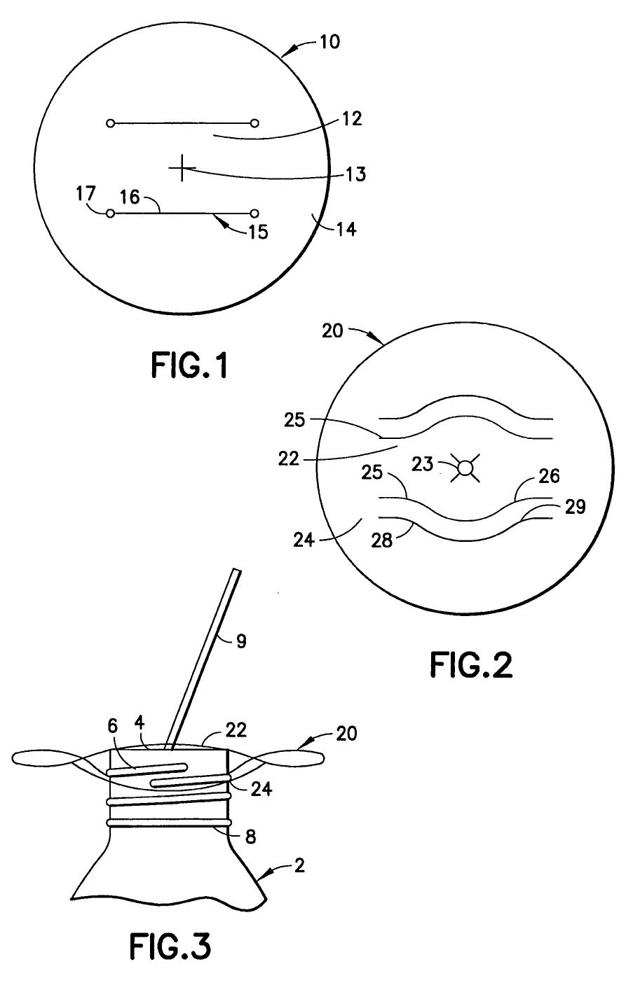

FIG. 1 depicts a first embodiment of the straw holder 10 according to the invention, which includes a central straw support portion 12 having an aperture 13 dimensioned to receive a straw in an interference fit, and a bottle retaining portion 14 separated from the straw support portion 12 by a pair of parallel rectilinear slits 15 having respective mutually facing edge portions 16 which are spaced to engage a bottle adjacent to its mouth. Each of the slits 15 terminates at a pair of holes 17 which relieve strain so that a tear will not readily propagate through the portion 14 from the slit 15. An additional pair of slits may be provided parallel to and outside of the slits 15, in order to engage a bottle having a wider mouth.

In this and other embodiments described herein, the straw holder is made of a flexible sheet material such as cardboard or plastic, wherein the slits and other defining features are preferably formed by die-cutting.

FIG. 2 depicts a second embodiment of the straw holder 20 according to the invention, which includes a central straw support portion 22 having an aperture 23 dimensioned to receive a straw in an interference fit, and a bottle retaining portion 24 separated from the straw support portion 22 by a pair of slits 25 having respective curved edge portions 26 which face each other concavely and are spaced to engage a bottle adjacent to its mouth. An additional pair of slits 28 having curved edge portions 29 is provided for engaging a bottle having a wider mouth.

FIG. 3 shows the straw holder 20 fitted to a bottle 2 having a mouth 4, ramps 6 which serve to retain a screw-on cap (not shown) and a flange 8. The straw holder 20 is fitted to the bottle with the straw support portion 22 against the mouth for supporting a straw 9 received in the aperture 23 (FIG. 2), and the bottle retaining portion 24 is flexed out of the plane of the straw support portion 22 so that the curved edge portions 26 engage the ramps 6 to retain the straw holder on the bottle. The straw holder 10 of FIG. 1 would be fitted in much the same way. The straw retaining portion may also engage the flange of a conventional bottle which does not have ramps, e.g. a beverage bottle with a crimped-on cap.

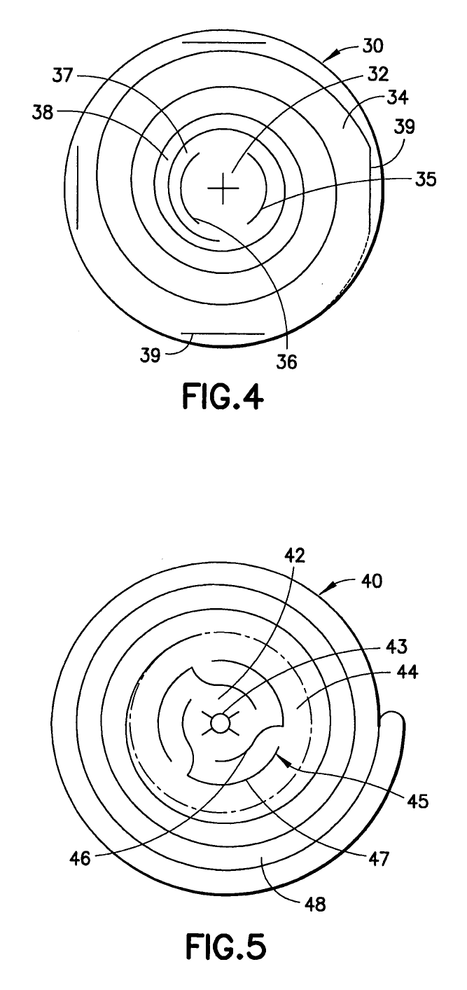

FIG. 4 depicts a third embodiment of a straw holder 30 with a straw support portion 32 and a bottle retaining portion 34 separated therefrom by slits 35 having curved edge portions 36 for engaging the ramps or flange of a bottle substantially as shown in FIG. 3. The bottle retaining portion further comprises a series of spiral turns including a first turn 37 and a second turn 38 which can provide additional bottle retention, as described more fully in U.S. application Ser. No. 10/684,882 filed on Oct. 14, 2003, the disclosure of which is incorporated herein by reference. The retaining portion 34 may also be provided with slits 39 for retaining a CD, in particular a three inch diameter CD included with the straw holder for promotional purposes as a value added item.

FIG. 5 depicts a fourth embodiment of a straw holder 40 having a straw support portion 42 with a straw receiving aperture 43 and a bottle retaining portion 44 separated from the portion 42 by slits 45. Each slit 45 has a first curved edge portion 46 and a second curved edge portion 47. The slits 45 overlap each other so that the first curved edge portion 46 of each slit lies radially inside of the second curved edge portion 47 of another slit. This permits the straw holder 50 to be fitted to a wider range of bottle sizes, because either the first edge portions 46 or the second edge portions 47 can engage the flange or ramps of a bottle. The bottle retaining portion 44 may further include spiral turns 48 for additional bottle retention, as described in conjunction with FIG. 4.

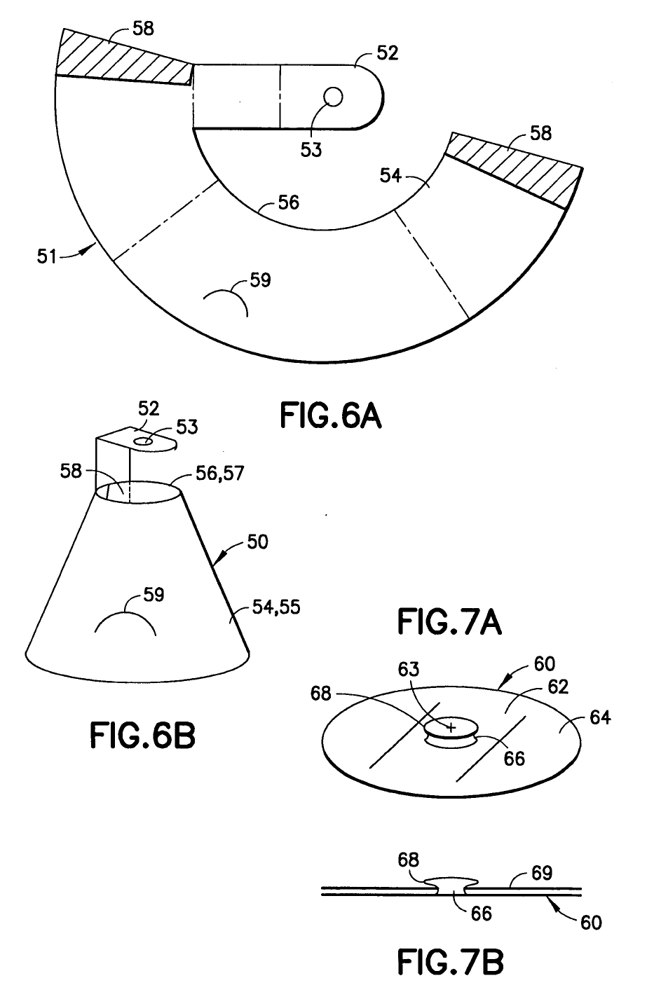

FIG. 6A shows a die-cut blank 51 for a straw holder 50 as depicted in FIG. 6B. The blank 51 includes a straw support portion 52 having an aperture 53, and a bottle retaining portion 54 having a circular top edge 56. The bottle retaining portion 54 is substantially semi-circular and has opposed ends 58 which are overlapped and glued together to form the frustoconical skirt 55 of the straw holder 50. As shown in FIG. 6B, the edge portions 57 are formed by the top edge 56, which can be slipped around the neck of a bottle. The blank 51 may also be provided with a slit 59 for retaining a bottle cap.

FIG. 7A shows a straw holder 60 having a straw support portion 62 and a bottle retaining portion 64 separated from the portion 62 by slits 65. The straw support portion 62 is molded with a central post 66 having a top flange 68, the straw retaining aperture 63 being cut in a top surface of the post 66. As shown in FIG. 7B, the flange 68 is dimensioned to be received through the central aperture of a CD 69 in an interference fit. The straw holder 60 may therefore be provided with a promotional CD at the point of sale.

The invention is not limited by the embodiments described above which are presented as examples only but can be modified in various ways within the scope of protection defined by the appended patent claims.

1. A straw holder for supporting a drinking straw in the mouth of a bottle, the straw holder being formed of a flexible sheet material and comprising:
a straw support portion dimensioned for placement above the mouth of a bottle and comprising an aperture designed to receive a straw therethrough and to vertically support said straw with respect to said support portion; and
a bottle retaining portion surrounding said support portion and having at least two edge portions facing said support portion and spaced apart for engaging the bottle adjacent to the mouth, the support portion being attached to the bottle retaining portion by at least one connection located between the edge portions.

2. A straw holder as in claim 1 wherein said edge portions are part of a continuous circumferential edge which is interrupted by a single said connection where the bottle retaining portion is attached to the support portion.

3. A straw holder as in claim 1 comprising at least two said connections corresponding to respective said edge portions, said edge portions being separated by said connections.

4. A straw holder as in claim 3 wherein said edge portions are uniformly spaced around said straw support portion.

5. A straw holder as in claim 4 comprising three said edge portions separated by three said connections spaced 120 degrees apart.

6. A straw holder as in claim 1 wherein said straw support portion and said bottle retaining portion are formed as one piece.

7. A straw holder as in claim 6 wherein said edge portions are formed by respective slits in said sheet of flexible material, said slits separating said straw support portion from said bottle retaining portion.

8. A straw holder as in claim 7 wherein said slits are circumferentially spaced apart from each other.

9. A straw holder as in claim 7 wherein said slits overlap each other circumferentially.

10. A straw holder as in claim 9 wherein each said slit comprises a first curved edge portion and a second curved edge portion, said first curved edge portion of each said slit lying radially inside of the second curved edge portion of another said slit.

11. A straw holder as in claim 1 wherein said bottle retaining portion further comprises a first turn lying radially outside of said edge portions and extending around said edge portions.

12. A straw holder as in claim 1 wherein said bottle retaining portion comprises a plurality of turns including a second turn connected to said first turn.

13. A straw holder as in claim 1 wherein said edge portions are formed by a pair of slits in said flexible sheet material.

14. A straw holder as in claim 13 wherein each said slit has opposite ends formed as round holes which provide strain relief.

15. A straw holder as in claim 13 wherein said slits are parallel substantially rectilinear slits.

16. A straw holder as in claim 13 wherein said edge portions are curved edge portions which face each other concavely.

17. A straw holder as in claim 1 wherein said bottle retaining portion comprises a frustoconical skirt having a circular top edge which comprises said edge portions, said straw support portion being attached to said top edge by said connection between said edge portions.

18. A straw holder as in claim 17 wherein said straw support portion comprises a tab extending from said circular top edge, said aperture being formed in said tab.

19. A straw holder as in claim 17 wherein said straw support portion and said bottle retaining portion are formed as one piece.

20. A straw holder as in claim 19 wherein said frustoconical skirt is formed from an arcuate segment having opposed ends which are overlapped and fixed together to form said skirt.

21. A straw holder as in claim 1 wherein said bottle retaining portion is formed with a plurality of circumferentially spaced slits for retaining a disk.

22. A straw holder as in claim 1 wherein said bottle retaining portion is formed with a slit for holding a bottle cap.

23. A straw holder as in claim 1 further comprising a post formed in said straw retaining portion, said post being provided with a circumferential flange dimensioned for an interference fit in the central aperture of a CD, the aperture being provided centrally of said flange.

24. A straw holder for supporting a drinking straw in the mouth of a bottle, the straw holder being formed of a flexible sheet material and comprising:
a straw support portion dimensioned for placement above the mouth of a bottle and comprising an aperture designed to receive a straw therethrough and to vertically support said straw with respect to said support portion; and
a bottle retaining portion surrounding the straw support portion and separated from the straw support portion by at least one pair of slits, each slit having an edge portion facing said support portion and spaced from another said edge portion for engaging the bottle adjacent to the mouth, the support portion being attached to the bottle retaining portion by at least one pair of connections located between the slits.

25. A straw holder as in claim 24 wherein each said slit has opposite ends formed as round holes which provide strain relief.

26. A straw holder as in claim 24 wherein at least one said pair of slits comprises parallel, substantially rectilinear slits.

27. A straw holder as in claim 24 wherein the edge portions of at least one said pair of slits are curved edge portions which face each other concavely.

28. A straw holder as in claim 24 comprising two pairs of slits separating the straw support portion from the bottle retaining portion.

29. A straw holder for supporting a drinking straw in the mouth of a bottle, the straw holder being formed of a flexible sheet material and comprising:
a straw support portion dimensioned for placement above the mouth of a bottle and comprising an aperture designed to receive a straw therethrough and to vertically support said straw with respect to said support portion; and
a bottle retaining portion comprising a frustoconical skirt surrounding said support portion, the frustoconical skirt having a circular top edge for engaging the bottle adjacent to the mouth, the support portion being attached to the bottle retaining portion by a connection extending from the circular top edge.

30. A straw holder as in claim 29 wherein the straw support portion comprises a tab extending from the circular top edge, the aperture being formed in the tab.

31. A straw holder as in claim 29 wherein the straw support portion and the bottle retaining portion are formed as one piece.

32. A straw holder as in claim 31 wherein the straw support portion is formed from an arcuate segment having opposed ends which are overlapped and fixed together to form the skirt.
